(19) United States
(12) Patent Application Publication
(10) Pub. No.: US 2023/0034644 A1
(43) Pub. Date: Feb. 2, 2023

(54) FIREPROOF, LIGHTWEIGHT, POLYMER-POLYMER SOLID-STATE ELECTROLYTE FOR SAFE LITHIUM BATTERIES

(71) Applicant: The Board of Trustees of the Leland Stanford Junior University, Stanford, CA (US)

(72) Inventors: Yi CUI, Stanford, CA (US); Jiayu WAN, Stanford, CA (US); Yi CUI, Stanford, CA (US); Yusheng YE, Stanford, CA (US)

(73) Assignee: The Board of Trustees of the Leland Stanford Junior University, Stanford, CA (US)

(21) Appl. No.: 17/788,274

(22) PCT Filed: Dec. 23, 2020
(86) PCT No.: PCT/US2020/066868

§ 371 Date: Jun. 22, 2022

Related U.S. Application Data
(60) Provisional application No. 62/953,356, filed on Dec. 24, 2019.

(51) Int. Cl. H01M 10/0565

(52) U.S. Cl. CPC H01M 10/0565; H01M 2300/0082; H01M 2004/027

(57) ABSTRACT

Embodiments of the present disclosure include solid-state electrolytes comprising a porous host and solid polymer electrolyte fillers dispersed within pores of the porous host. Further embodiments include batteries comprising an anode, a cathode, and a solid-state electrolyte of the disclosure disposed between the anode and the cathode.

### CROSS-REFERENCE TO RELATED APPLICATIONS

This application claims the benefit of and priority to U.S. Patent Provisional Application No. 62/953,356, filed on Dec. 24, 2019, the contents of which are incorporated herein in their entirety.

### STATEMENT REGARDING FEDERALLY SPONSORED RESEARCH OR DEVELOPMENT

This invention was made with Government support under contract Battery 500 awarded by the Department of Energy and under contract 233021 awarded by the Pacific Northwest National Laboratory. The Government has certain rights in the invention.

### BACKGROUND

Safety issues in lithium-ion batteries are becoming a serious concern due to their ubiquitous utilization and close contact with human body. Replacing flammable liquid electrolyte, solid-state electrolytes (SSEs) are thought to address this issue as well as providing unmatched energy densities in Li based batteries. However, among the most intensively studied SSEs, polymeric solid electrolyte and polymer/ceramic composites are usually flammable, leaving the safety issue unattended.

It is against this background that a need arose to develop the embodiments described herein.

### SUMMARY

Some embodiments include a solid-state electrolyte comprising a porous host and solid polymer electrolyte fillers dispersed within pores of the porous host. In some embodiments, the porous host includes a porous polymer film and a flame-retardant material dispersed in the porous polymer film. In some embodiments, the porous polymer film includes a polyimide. In some embodiments, the flame-retardant material includes decabromodiphenyl ethane. In some embodiments, the pores have sizes in a range of about 1 nm to about 10 μm, about 10 nm to about 10 μm, about 100 nm to about 10 μm, or about 100 nm to about 1 μm. In some embodiments, the solid polymer electrolyte fillers include a solid polymer and a lithium salt. In some embodiments, the solid polymer includes a polyalkylene oxide. In some embodiments, the polyalkylene oxide is polyethylene oxide. In some embodiments, the lithium salt includes lithium bis(trifluoromethanesulfonylimide. Other embodiments include a battery comprising an anode, a cathode, and the solid-state electrolyte of any of the embodiments herein disposed between the anode and the cathode. In some embodiments, the anode includes lithium metal.

### BRIEF DESCRIPTION OF THE DRAWINGS

FIG. 1(a) shows comparative lithium-based batteries based on liquid and solid polymer-based electrolytes, which are still flammable. FIG. 1(b) shows design principles of certain embodiments of the fireproof and lightweight polymer-polymer solid-state electrolyte. FIG. 1(c) shows photo image of an embodiment of a porous PI/DBDPE film.

FIG. 2(a) shows a SEM image of an embodiment of the PI/DBDPE film's surface morphology facing air in the doctor balding process (inset shows typical magnified SEM image of FIG. 2(a)). FIG. 2(b) shows a SEM image of an embodiment of the PI/DBDPE film's surface morphology facing glass in the doctor balding process (inset shows typical magnified SEM image of FIG. 2(b)). FIG. 2(c) shows a cross-section SEM of an embodiment of a typical PI/DBDPE film showing the thickness of PI/DBDPE film (inset shows typical magnified SEM image of FIG. 2(c)). Orange dashed circles represent DBDPE particles. FIG. 2(d) shows FTIR spectra of an embodiment of the PI film and an embodiment of DBDPE particles. FIG. 2(e) shows an embodiment of the DSC spectra of the porous PI/DBDPE film, porous PI film, and PEO/LiTFSI film. FIG. 2(f) shows stress-strain curve of the porous PI/DBDPE film, porous PI film, and PEO/LiTFSI film.

FIG. 3(a) shows an embodiment of the SET of the PEO/LiTFSI with different weight percentage of DBDPE. FIG. 3(b) shows a mechanism for the flame retardance effects of DBDPE. Flame tests of FIG. 3(c) an embodiment of PEO/LiTFSI, FIG. 3(d) an embodiment of PI/DBDPE, and FIG. 3(e) an embodiment of PI/DBDPE/PEO/LiTFSI.

FIG. 4(a) shows an embodiment of long-term cycling of symmetrical Li-Li cells with PI/DBDPE/PEO/LiTFSI SSE and PEO/LiTFSI thin-film electrolyte at about 60° C. Each cycle lasts for about one hour. FIG. 4(b) shows an embodiment of a voltage profile of symmetrical Li-Li cells with PI/DBDPE/PEO/LiTFSI SSE and PEO/LiTFSI thin-film electrolyte from 0^{th} to 10^{th} cycles and from 290^{th} to 300^{th} cycles. FIG. 4(c) shows an embodiment of a voltage profile of a Li/PI/DBDPE/PEO/LiTFSI/LFP cell at different charging rates, cycled at about 60° C. Black dashed line represents the Li/PEO/LiTFSI/LFP cell at about C/10, cycled at about 60° C. FIG. 4(d) shows an embodiment of rate performance of a Li/PEO/LiTFSI/LFP cell and a Li/PI/DBDPE/PEO/LiTFSI/LFP cell, cycled at about 60° C. FIG. 4(e) shows an embodiment of cycling performance of Li/PEO/LiTFSI/LFP and Li/PI/DBDPE/PEO/LiTFSI/LFP cells at about C/2, cycled at about 60° C.

FIG. 5(a) shows photo images of an embodiment of PE separator, PEO/LiTFSI, and PI/DBDPE film before/after exposure to thermal shock (about 150° C., about 0.5 h), respectively. FIG. 5(b) shows a schematic illustration an embodiment of the thermal abuse test of pouch cell battery with LFP as the cathode and LTO as the anode. FIGS. 5(c,d,e) show thermal abuse test of an embodiment of batteries with FIG. 5(c) EC/DEC/PE, FIG. 5(d) PEO/LiTFSI, and FIG. 5(e) PI/DBDPE/PEO/LiTFSI as the electrolyte, respectively.

FIG. 6(a) shows an embodiment of PEO/LiTFSI/about 30 wt % LLZO and FIG. 6(b) shows an embodiment of PEO/LiTFSI/about 30 wt % Al₂O₃.

FIG. 7 shows an embodiment of a schematic illustration of the synthetic procedure of PI/DBDPE nanoporous film. FIG. 7(a) shows an embodiment where the reactants were kept under magnetic stirring to obtain PAA/DBDPE solution. FIG. 7(b) shows doctor balding process. FIG. 7(c) shows an embodiment of the PAA/DBDPE film that was immersed in DMAC/EtOH solution to create the porous structure. FIG. 7(d) shows an embodiment of the porous PAA/DBDPE film was heated at about 300° C. to form porous PI/DBDPE film.

FIG. 8 shows a SEM image of an embodiment of DBDPE particles.

FIG. 9 shows an embodiment of a SEM images of the PI film's surface, which are the surface morphology FIG. 9(a) shows facing air and FIG. 9(b) shows facing glass in the doctor blading process, respectively. FIG. 9(c) shows a cross-section SEM image of an embodiment of a typical PI film.

FIG. 10(a) shows a flame test of an embodiment of PEO/LiTFSI/about 15 wt % DBDPE. FIG. 10(b) shows a flame test of an embodiment of a PI film. FIG. 10(c) shows a flame test of an embodiment of a PI/PEO/LiTFSI film.

### DETAILED DESCRIPTION

Here, this disclosure reports the first design of a fireproof, ultralightweight polymer-polymer SSE. In some embodiments, the SSE is comprises of porous mechanic enforcer (e.g., polyimide, PI), fire-retardant additive (e.g., decabromodiphenyl ethane, DBDPE), and polymer electrolyte (e.g., polyethylene oxide/lithium bis(trifluoromethanesulfonyl)imide). In some embodiments, the whole SSE is made from organic materials, with thin, tunable thickness (about 10-25 μm) which provide an energy density comparable to comparative separator/liquid electrolyte. The embodiments of the film (e.g., PI/DBDPE film) are thermally stable, nonflammable, and mechanically strong, preventing Li-Li symmetrical cell from short-circuiting after more than 300 h of cycling. LiFePO₄/Li half cells with the SSE show high rate performance (about 131 mAh g⁻¹ at about 1 C) as well as cycling performance (300 cycles at about C/2 rate) at about 60° C. Most intriguingly, pouch cells made with the polymer-polymer SSE embodiments still function well even under flame in the abuse tests.

In some embodiments, a solid-state electrolyte includes a porous host and solid polymer electrolyte fillers dispersed within pores of the porous host.

In some embodiments, the porous host includes a porous polymer film and a flame-retardant material dispersed in the porous polymer film. The composition of the porous polymeric film or layer is not particularly limited. In some embodiments, the porous polymeric film or layer is compatible as a solid electrolyte or in a battery of other similar device. In some embodiments, the porous polymeric film or layer comprises a uniform mixture of a solid polymer. Examples of suitable polymers include, but are not limited to polyimides or another polymer or mixture of polymers that are nonflammable and mechanically strong. Additional non-limiting embodiments, polytetrafluoroethylene (PTFE), polyacrylonitrile (PAN), nylon, polyethylene, polypropylene, polystyrene, kevlar, fiberglass, polyolefin and the like. In some embodiments, the porous polymer film includes a polyimide. The composition of the flame-retardant material is not particularly limited. In some embodiments, the flame-retardant material is compatible in a solid electrolyte or in a battery of other similar device. Examples of suitable flame-retardant materials include organohalogen compounds, such as decabromodiphenyl ethane, hexabromocyclododecane (HBCD), tetrabromobisphenol A (TBBPA), decabromodiphenyl ether (Deca-BDE or DeBDE) and the like. Additional examples of suitable flame-retardant materials include organophosphorus compounds (e.g., resorcinol bis(diphenyl phosphate) (RDP), triphenyl phosphate (TPP) and the like) and compounds containing both phosphorus and a halogen (e.g., tris(1,3-dichloro-2-propyl)phosphate (TDCPP), tris(2,3-dibromopropyl) phosphate (brominated tris) and the like). In some embodiments, the flame-retardant material includes decabromodiphenyl ethane.

In some embodiments, the pores have sizes in a range of about 1 nm to about 10 μm, about 10 nm to about 10 μm, about 100 nm to about 10 μm, or about 100 nm to about 1 μm.

In some embodiments, the solid polymer electrolyte fillers include a solid polymer and a lithium salt. The composition of the solid polymer is not particularly limited. In some embodiments, the solid polymer is compatible in a solid electrolyte battery of other similar device. Examples of suitable solid polymers include polyalkylene oxide, e.g., polyethylene oxide (PEO), poly(propylene oxide) (PPO), and the like), poly(tetrahydrofuran) (PTHF), poly(ethylene carbonate) (PEC), poly(vinylene carbonate) (PVCa), perfluoropolyether (PFPE), poly(ethylenimine) (PEI), and the like. In some embodiments, the solid polymer is a single polymer or a mixture or copolymer. In some embodiments, the solid polymer includes a polyalkylene oxide. In some embodiments, the polyalkylene oxide is polyethylene oxide. The lithium salt is not particularly limited. In some embodiments, the lithium salt is compatible in a solid electrolyte battery of other similar device. Examples of suitable lithium salts include lithium trifluoromethanesulfonate lithium bis(fluorosulfonyl)imide, lithium bis(trifluoromethanesulfonyl)imide, lithium hexafluorophosphate, lithium hexafluoroarsenate, lithium tetrafluoroborate, lithium perchlorate, lithium triflate, and the like. In some embodiments, the lithium salt includes lithium bis(trifluoromethanesulfonylimide.

In additional embodiments, a battery includes an anode, a cathode, and the solid-state electrolyte of any of the foregoing embodiments disposed between the anode and the cathode. In some embodiments, the anode includes lithium metal or other material suitable for a battery (e.g., Li-ion battery), such as graphite. In some embodiments, the cathode material is a suitable material for a battery(e.g., Li-ion battery), e.g., a material containing lithium that is suitable as a cathode, e.g., LiCoO₂, LiFePO₄, Li₂Mn₂O₄, Li₂FePO₄F, Li₂S, and the like. Additional configurations include, e.g., a Li-air battery configuration.

### EXAMPLES

Li-ion batteries (LIBs) are considered as the dominant energy storage devices and ubiquitously applied in modern society from portable electronics to grid scale storage. In pursuit of LIBs with higher energy density, metallic Li anode with high capacity and high voltage cathodes has been intensively studied. However, the increasing demand of energy/power density of LIBs arouses serious safety concerns. Uncontrollable dendritic Li plating triggered at high current density and accumulated with cycling can penetrate through the separator, leading to intense heat release via internal short circuit and a potential explosion hazard. There have been a variety of strategies to enhance liquid electrolyte-based battery safety, including ceramic particles coating onto separators, fire retardants in electrolyte, half-short detection, internal thermal switch, and fire retardant encapsulation by polymer. Still, replacing soft, flammable separator/liquid electrolyte, emerging solid-state electrolytes (SSEs) could potentially suppress the dendritic Li formation and provide intrinsic safe operation solutions to LIBs. Comparative SSEs can be summarized in three categories: inorganic (ceramic/glass) solid electrolytes, solid polymer electrolytes (SPEs), and their hybrids. The inorganic solid electrolytes have attracted great attention due to the highest ionic conductivity among all types of SSEs. Lithium supertonic conductors can have an exceptionally high conductivity (25 mS cm⁻¹ for Li_{9.54}Si_{1.74}P_{1.44}S_{11.7}Cl_{0.3}), even exceeding that of liquid electrolytes. However, air instability, brittleness, large interfacial impedance, and the fact that Li still penetrate inorganic SSEs after critical current density hinder the use of these SSEs in Li-ion batteries. An intrinsic high electronic conductivity in certain inorganic SSEs, especially at grain boundaries, can lead to hazardous direct Li deposition inside of SSEs. In addition, the energy density of batteries with these SSEs are significantly lowered due to the high density and large thickness of inorganic electrolytes.

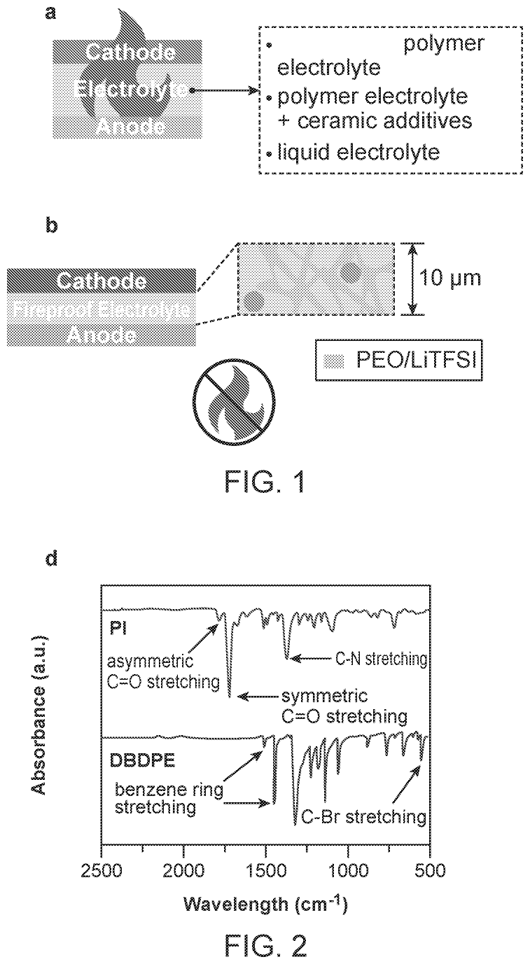

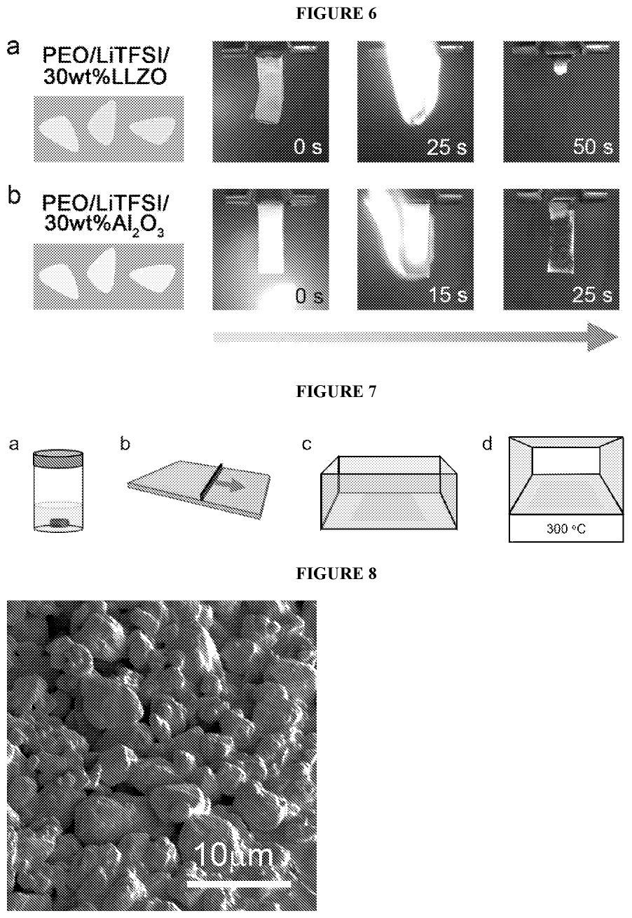

SPEs are mainly composed of solid polymers and Li salts, where the solid mixtures serve as Li-ion conductors. Polyethylene oxide (PEO)/Li salts is a considered polymer system due to the flexibility, low cost, light weight, and high Li-ion conductivity among all SPEs. However, the intrinsic softness of this polymer system makes it unable to suppress the Li dendrite propagation, which restricts its application in LIBs. To circumvent this problem, strategies such as reinforcing with nanoparticles, crosslinking, and applying with robust host are considered. Despite their success, most of these composite polymeric SSEs are still flammable (FIG. 1(a)). Investigation is made of the flammability of a comparative nanocomposite SSEs. Both PEO/LiTFSI/about 30 wt % LLZO (FIG. 6(a)) and PEO/LiTFSI/about 30 wt % Al₂O₃ (FIG. 6(b)) can still caught fire easily, leaving the original battery safety concern unaddressed.

In this disclosure, proposed is the design of a fireproof and ultra-lightweight SSE with excellent electrochemical performance for lithium batteries. The design principles of the fireproof polymer-polymer solid-state electrolyte are shown in FIG. 1(b). The composite SSE is made of a porous bi-functional PI host with Li-ion conductive SPE fillers. The bi-functional host, is composed of nonflammable and robust, about 10-μm-thick porous polyimide (PI) film with lightweight flame-retardant material decabromodiphenyl ethane (DBDPE), which is not only mechanical strong to prevent potential lithium dendrite penetration but also provides the fireproof ability of SSE. The SPE fillers are composed of PEO/lithium bis(trifluoromethanesulfonylimide (LiTFSI), ensuing high ionic conductivity of SSEs. The ultrathin and polymer-polymer nature of the composite electrolyte provides great flexibility, low electrolyte resistance and potential high energy density of full batteries. When thermal runaway happens in the battery with PI/DBDPE/PEO/LiTFSI SSE, the flame retardant DBDPE in the nonflammable PI host will effectively suppress the combustion of the flammable PEO/LiTFSI. FIG. 7 shows the synthetic procedure of the PI/DBDPE film. Firstly preparation is made of intermediate polyamic acid (PAA) solution with DBDPE (see supplementary methods for more details). The solution was then coated onto a glass substrate by doctor blading to produce the PAA/DBDPE film. The dimethylacetamide/ethanol (DMAC/EtOH) solution was used to make the porous PAA/DBDPE film. After drying, the porous PAA/DBDPE film is imidized at about 300° C. to yield the final porous PI/DBDPE film. The facial, solution-based process allows potential scalable production of such host. FIG. 1(c) shows the photo image of the final PI/DBDPE film.

Detailed characterizations of PI/DBDPE film were carried out using scanning electron microscopy (SEM). FIG. 2(a) shows the surface morphology of PI/DBDPE film on the air-facing side during doctor blading process. The pores and DBDPE particles were uniformly distributed on the air-facing surface of PI/DBDPE film. The magnified SEM image of air-facing surface on PI/DBDPE film shows that the diameter of the pores were about 500 nm. The orange dashed circle represents the DBDPE particle. As shown in FIG. 8, the diameter of DBDPE particles ranged from submicron to a few microns. The surface morphology of PI/DBDPE film on the glass-facing side is shown in FIG. 2(b), on which DBDPE particles are less than that on the air-facing side. The pores were well-distributed on the surface facing glass with the pore sizes of about 500 nm, similar to that facing air. The cross-section SEM of the typical PI/DBDPE film exhibited excellent uniformity with constant thickness of about 10 μm (FIG. 2(c)). It is noted that, by applying doctor blading with various gap depths, the thickness of the film (about 10-25 μm) can be readily tuned. The porous structure of PI/DBDPE film was further confirmed by the magnified SEM, where the orange dashed circles represent the DBDPE particles. The nanopores inside PI/DBDPE film distributed uniformly and the sizes were determined to be about 500 nm.

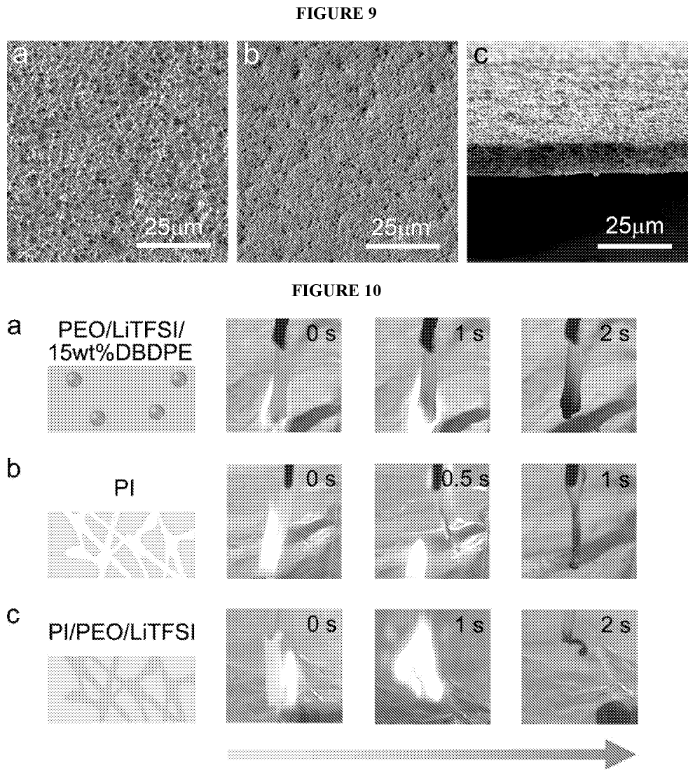

Preparation is made of pure porous PI film with similar thickness as comparison. FIG. 9) shows SEM characterizations of porous PI film. The surface morphology of the porous PI film on both air-facing side and glass-facing side shows that the pores were uniformly distributed (FIG. 9(a), 9(b)). The diameter of pores was determined to be about 1 μm and about 500 nm on the air-facing side and glass-facing side, respectively. As shown in the cross-section SEM, the thickness of porous PI film was identified to be about 10 μm, similar to that of PI/DBDPE film (FIG. 9(c)). FIG. 2(d) shows the typical FTIR spectra of the PI film and DBDPE particles. Strong characteristic symmetric C═0 stretching and C—N stretching signals of PI were identified at about 1719.2 cm⁻¹ and about 1372.1 cm⁻¹, respectively. Peaks at about 1449.7 cm⁻¹ and about 554.4 cm⁻¹ of DBDPE were ascribed to strong C═C stretching of benzene ring and C—Br stretching signals, respectively. All the peaks match well with PI and DBDPE, which confirms the chemical composition of the synthesized PI, DBDPE and PI/DBDPE film.

Thermal stability is an important parameter of a separator. A low melting temperature of a separator can give rise to severe separator shrinkage in the early stage of internal short circuit, which may accelerate the thermal runaway process. FIG. 2(e) shows the differential scanning calorimetry analysis (DSC) of PI/DBDPE, PI, and PEO/LiTFSI film. No endothermic peak corresponding to polymer melting was observed for the PI/DBDPE and PI film in the whole scanning range, while PEO/LiTFSI exhibited a strong endothermic peak at about 180° C. As such, PI/DBDPE and PI film showed a much higher thermal stability than PEO/LiTFSI. Stress-strain curves of PI/DBDPE, PI, and PEO/LiTFSI film obtained through tensile tests were plotted in FIG. 2(f). The porous PI/DBDPE film showed a shear modulus of about 440 MPa, slightly lower than that of pure porous PI film (about 470 MPa), but almost four orders of magnitude higher than that of PEO/LiTFSI (about 0.1 MPa). In this case the mechanical strength of PI/DBDPE film was similar to that of PI film, but much larger than that of PEO/LiTFSI.

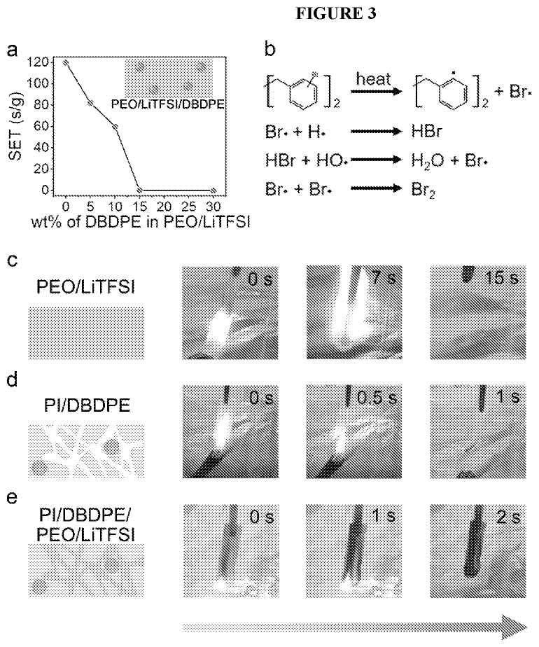

To quantitatively explore the flame retardant property of DBDPE, measurement is made of the self-extinguishing time (SET) of PEO/LiTFSI electrolytes with different DBDPE concentrations (FIG. 3(a)). The SET was obtained by normalizing the flame combustion time against the electrolyte mass. The pristine PEO/LiTFSI was highly flammable with a SET of about 120 s/g. The SET of the PEO/LiTFSI gradually decreased as the DBDPE was added, indicating the flammability of PEO/LiTFSI was reduced as the weight percentage of DBDPE increased. The SET value dropped to zero when the concentration of DBDPE in PEO/LiTFSI increased to about 15 wt % (FIG. 10(a)). The mechanism for the fireproof property of DBDPE was proposed to be the free-radical scavenging reaction (FIG. 3(b)). DBDPE can degrade to generate Bromo free radicals (Br⋅) upon heated. The highly reactive radicals H⋅ and OH⋅ emitted by the burning electrolyte can be captured by Br⋅, weakening or terminating combustion chain branching reactions. Moreover, the gas phase product such as HBr, H₂O, and Br₂ released in free-radical scavenging reaction limits the heat and mass transfer. These gas products dilute the concentration of oxygen between the heat source and electrolyte, thus retarding the self-sustaining combustion.

The efficiency of DBDPE in suppressing the combustion of PI/DBDPE/PEO/LiTFSI SSE was studied by flame test. The weight percentage of DBDPE was determined to be about 30% in PI film. PEO/LiTFSI and PI/DBDPE film served as control samples. The PI/DBDPE/PEO/LiTFSI film exhibited excellent flame retardancy in flame test. As shown in FIG. 3(c), PEO/LiTFSI without DBDPE caught fire immediately as the lighter approached and then combusted violently. FIG. 3(d) shows the flame test of the porous PI/DBDPE film. The PI/DBDPE film twisted because of the extreme heat, but did not catch fire. After the pores of PI/DBDPE film was filled with the flammable PEO/LiTFSI, the ignition and burning of PEO/LiTFSI was effectively suppressed and the SSE remain intact, because of the fireproof material DBDPE in the SSEs (FIG. 3(e)). To further investigate the fireproof property of DBDPE, examination is made of PI and PI/PEO/LiTFSI to flame test as contrast. The PI film was nonflammable as shown in FIG. 10(b). However, PI/PEO/LiTFSI was easily ignited (FIG. 10(c)), indicating the role of DBDPE in suppressing the combustion of SSE.

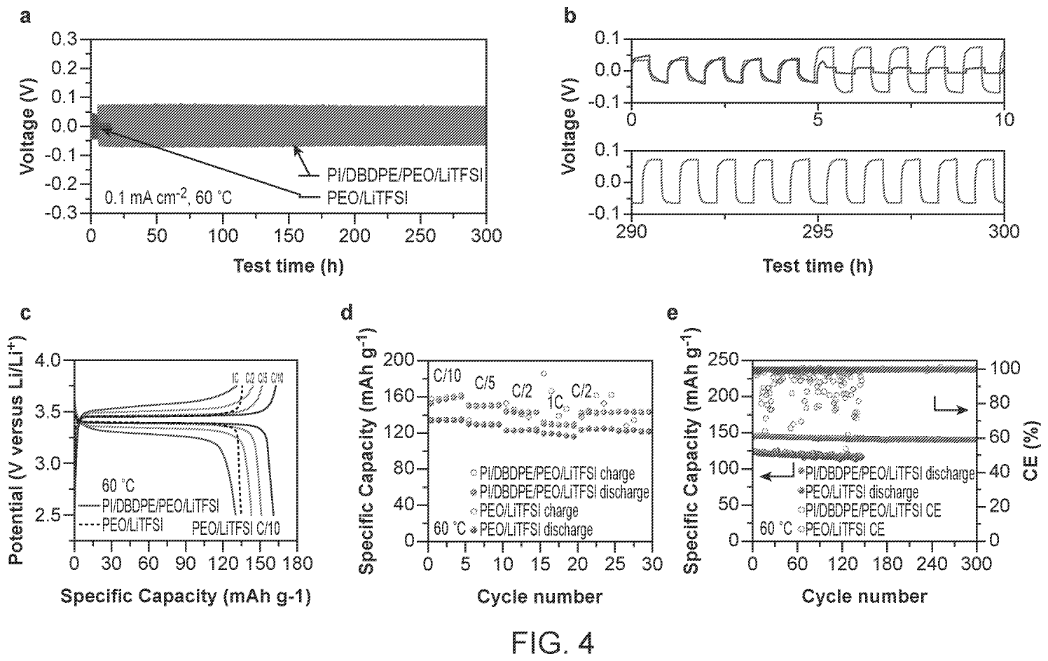

The cycling test of Li/SSE/Li symmetric cells was carried out to evaluate the mechanical stability of PI/DBDPE/PEO/LiTFSI SSE during the Li plating and striping process (FIG. 4a). The current density was firstly set to be about 0.05 mA cm⁻² at about 60° C. to activate the Li/SSE/Li symmetric cells. After the current density was improved to be about 0.1 mA cm⁻² at the sixth cycle, a hard short occured immediately in plain PEO/LiTFSI cells (FIG. 4b). However, the PI/DBDPE/PEO/LiTFSI SSE demonstrated much more stable performance during Li plating and stripping, lasting about 300 h at about 60° C. The long, durable performance resulted from the increased modulus of the PI/DBDPE/PEO/LiTFSI SSE, indicating the ability of the proposed high-modulus-matrix structures to prevent dendrite formation.

The electrochemical test of PI/DBDPE/PEO/LiTFSI SSE was conducted at about 60° C. in half cells. The cathode and anode of the coin cell were made with LiFePO₄ (LFP) and Li metal, respectively. Control cells were made with the same cathodes and anodes, except for PEO/LiTFSI as the solid-state electrolyte. As shown in FIG. 4(c), the PI/DBDPE/PEO/LiTFSI cells delivered excellent rate performance. Voltage profiles at different rates showed clear plateaus at about 3.45 V, which was typical for LFP cathodes. The PI/DBDPE/PEO/LiTFSI cell maintained very low overpotentials of about 40 mV at about C/10 rates, reflecting the thin nature, thus low ionic resistance of PI/DBDPE/PEO/LiTFSI film. In contrast, a relatively large overpotential of about 56 mV was observed at about C/10 for LFP/PEO/LiTFSI/Li. When cycled at about C/10, about C/5, about C/2, and about 1 C, the LFP/PI/DBDPE/PEO/LiTFSI/Li half-cell delivered high specific capacities of about 163 mAh g⁻¹, about 152 mAh g⁻¹, about 143 mAh g⁻¹, and about 131 mAh g⁻¹, respectively (FIG. 4(d)). However, the specific capacities of LFP/PEO/LiTFSI/Li half cells were just about 134 mAh g⁻¹, about 129 mAh g⁻¹, about 122 mAh g⁻¹, and about 115 mAh g⁻¹when cycling at about C/10, about C/5, about C/2, and about 1 C, respectively, much lower than that of LFP/PI/DBDPE/PEO/LiTFSI/Li cell. These results demonstrated that the rate capability of PI/DBDPE/PEO/LiTFSI SSE was much better compared to PEO/LiTFSI SSE. FIG. 4(e) shows the specific capacity and Coulombic efficiency (CE) of the LFP/PI/DBDPE/PEO/LiTFSI/Li cell and LFP/PEO/LiTFSI/Li cell cycling at the rate of about C/2. The LFP/PI/DBDPE/PEO/LiTFSI/Li cell showed stable cycling for more than 300 cycles, whereas the CE of LFP/PEO/LiTFSI/Li cell varied dramatically during cycling. The electrochemical test results showed excellent performance of PI/DBDPE/PEO/LiTFSI SSE for battery operations.

Comparison is made of the thermal stability of PI/DBDPE matrix with PE separator and PEO/LiTFSI (FIG. 5(a)). After exposed to thermal shock conditions (about 150° C., about 0.5 h), the area of the PE separator shrank to half as large as that before thermal shock, while PEO/LiTFSI melted. In contrast, no substantial changes in the film dimension and morphology were observed in PI/DBDPE film. To highlight the superior safety of the PI/DBDPE/PEO/LiTFSI cell, a thermal abuse test was conducted. FIG. 5(b) shows the schematic illustration of the pouch cell battery working under flame test condition. The cathode and anode materials used for demonstration here were LFP and Li₄Ti₅O₁₂ (LTO), respectively, while the only difference in the pouch cells are the electrolytes. As shown in FIGS. 5(c)-5(e), the fully charged liquid electrolyte/polymer separator (EC/DEC/PE) cell, comparative polymer electrolyte (PEO/LiTFSI) cell, and the SSE (PI/DBDPE/PEO/LiTFSI) cell were exposed to flame. The EC/DEC/PE cell and PEO/LiTFSI cell could not light the LED bulbs after ignited for about 18 s and about 24 s, respectively. However, the LED bulb operated by PI/DBDPE/PEO/LiTFSI cell at about 24 s was still as bright as that before ignition. The remarkable abuse tolerance of the PI/DBDPE/PEO/LiTFSI cell is attributed to the highly thermally-stable PI/DBDPE film, indicating the potential of PI/DBDPE/PEO/LiTFSI SSE to improve the safety of lithium batteries.

In conclusion, fireproof and lightweight SSE with excellent electrochemical performance can be achieved by utilizing porous PI film with flame-retardant material DBDPE as the host and PEO/LiTFSI as the ionically conducting filler. Compared with PEO/Li salt-based SSEs, the hybrid electrolyte shows excellent flame-retardant ability. The modulus of the hybrid SSE is five orders of magnitude higher than that of plain PEO/LiTFSI electrolyte, leading to the superior cycling stability of PI/DBDPE/PEO/LiTFSI in Li/SSE/Li cells. Furthermore, the hybrid PI/DBDPE/PEO/LiTFSI solid electrolyte demonstrates better rate performance and cycling stability than that of plain PEO/LiTFSI in LFP/SSE/Li cells. LFP/PI/DBDPE/PEO/LiTFSI/Li all-solid-state pouch cells also exhibit high tolerance to abuses such as flame test. Therefore, the proposed polymer-polymer composite SSE configuration represents a universal and promising route to make lithium batteries that are high energy density, high performing, and safe.

### Supplementary Methods

Chemicals and materials. N-methyl pyrrolidone (NMP, Sigma Aldrich), dimethylacetamide (DMAC, Sigma Aldrich), PEO (MW=300,000, Sigma Aldrich), LiTFSI (Solvay), acetonitrile (anhydrous, Sigma Aldrich), 4,4′-Oxydianiline (ODA, Sigma Aldrich), pyromellitic dianhydride (PMDA, Sigma Aldrich), 4,4′41,4-Phenylenebis(oxy)bis[3-(trifluoromethyl)aniline] (6FAPB, Sigma Aldrich), decabromodiphenyl ethane (DBDPE, Sigma Aldrich), ethanol (EtOH, Sigma Aldrich), LFP powders (MTI), carbon black (Sigma Aldrich), Li foil (Sigma Aldrich).

Preparation of PI/DBDPE film. About 1 g of NMP and about 9 g of DMAC was mixed in an about 20-mL vial under magnetic stirring for about 10 min. Then ODA (about 0.159 g), 6FAPB (about 0.341 g), and PMDA (about 0.556 g) was added in the mixed solution sequentially. It was noted that the time interval of adding the three samples should be more than about 30 min. Then about 0.452 g of DBDPE was added in the solution and was kept under magnetic stirring for about 12 hours to obtain PAA/DBDPE solution. Doctor blading was performed to coat the as-obtained solution on the glass. The gap depth varied from about 3 mil to about 10 mil was used to control the thickness of the film. After coating, the film was kept on the glass for about 60 min to ensure that NMP and DMAC were fully evaporated, followed by the rinsing of the film with DMAC and EtOH (v:v=about 1:1) for about 15 min for pores creation. The as obtained PAA/DBDPE nanoporous film was dried for about 60 min to fully evaporate the DMAC and EtOH. The dried nano-porous PAA/DBDPE film was imidized in a box furnace at air atmosphere to obtain PI/DBDPE film. The temperature ramping program was set as: (1) Ramp up from room temperature (RT) to about 100° C. at about 3° C. min⁻¹; (2) Keep at about 100° C. for about 30 min; (3) Ramp up to about 200° C. at about 3° C. min⁻¹; (4) Keep at about 200° C. for about 30 min; (5) Ramp up to about 300° C. at about 3° C. min⁻¹; (6) Keep at about 300° C. for about 30 min; (7) Cool down to RT in furnace.

Preparation of SSE. PEO was mixed with LiTFSI and acetonitrile using a Thinky mixer (Thinky Cooperation). The EO to Li ratio was about 10:1. Pure PEO/LiTFSI films were prepared by doctor blade casting followed by drying in a vacuum oven at about 60° C. for about 24 h and baking in an Ar-filled glove box at about 70° C. for at least about 48 h. PI/DBDPE/PEO/LiTFSI solid electrolytes were obtained in a facile two-stage process. First, as-prepared PEO/LiTFSI/acetonitrile solution drops were spun at about 4,000 r.p.m. with porous PI film. The as-prepared PI/DBDPE/PEO/LiTFSI film was then baked at about 180° C. under vacuum to ensure the full infiltration of PEO/LiTFSI in the nanopores. The excess PEO/LiTFSI was scraped off at about 150° C. on a hot plate. The PI/DBDPE/PEO/LiTF SI film then underwent the same drying process as the regular PEO/LiTFSI film.

Preparation of other battery components. LFP powders, PEO/LiTFSI and carbon black (w:w:w=about 60:25:15) were mixed in acetonitrile using a Thinky mixer. The LFP active material loading was about 1.5 mg cm⁻². The slurry was then bladed on Al foil to render uniform coating, which was further dried in vacuum oven at about 60° C. for at least about 48 h. Coin cells (2032 type, MTI) were made either with Li/SSE/Li or LFP/SSE/Li-type cells. LTO powders, PEO/LiTFSI and carbon black (w:w:w=about 60:25:15) were mixed in acetonitrile using a Thinky mixer. The slurry was then doctor blade casted on Cu foil. Pouch cells were made with LFP/SSE/LTO-type cells.

Materials characterizations. SEM images were obtained with a FEI XL30 Sirion SEM. Mechanical tests were undertaken with a TA instrument Q800 DMA.

Electrochemical characterizations. Long-term cycling of symmetrical Li-Li cells were conducted with a symmetrical Li/SSE/Li structure in coin cells (2032 type). Rate capability tests were carried out in LFP/SSE/Li-type coin cells (2032 type) with Bio-logic VMP3 and LAND systems. All temperature-controlled experiments were tested inside an environmental chamber (BTU-133, ESPEC North America) using a high-precision thermometer (±0.1° C.).

Flame test of SSEs. All of the SSEs were tailored to be with the same size (about 2 cm×0.5 cm) and similar thickness (about 50 μm).

Thermal abuse test of pouch cells. The pouch cells were made with LFP/SSE/LTO-type cells. EC/DEC/PE, PEO/LiTFSI, and PI/DBDPE/PEO/LiTFSI were used as the SSEs here.

As used herein, the singular terms “a,” “an,” and “the” include plural referents unless the context clearly dictates otherwise. Thus, for example, reference to an object can include multiple objects unless the context clearly dictates otherwise.

As used herein, the terms “connect,” “connected,” and “connection” refer to an operational coupling or linking. Connected objects can be directly coupled to one another or can be indirectly coupled to one another, such as via one or more other objects.

As used herein, the terms “substantially,” “substantial,” “approximately,” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, a first numerical value can be deemed to be “substantially” the same or equal to a second numerical value if the first numerical value is within a range of variation of less than or equal to ±10% of the second numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

While the disclosure has been described with reference to the specific embodiments thereof, it should be understood by those skilled in the art that various changes may be made and equivalents may be substituted without departing from the true spirit and scope of the disclosure as defined by the appended claim(s). In addition, many modifications may be made to adapt a particular situation, material, composition of matter, method, operation or operations, to the objective, spirit and scope of the disclosure. All such modifications are intended to be within the scope of the claim(s) appended hereto. In particular, while certain methods may have been described with reference to particular operations performed in a particular order, it will be understood that these operations may be combined, sub-divided, or re-ordered to form an equivalent method without departing from the teachings of the disclosure. Accordingly, unless specifically indicated herein, the order and grouping of the operations are not a limitation of the disclosure.

1. A solid-state electrolyte comprising a porous host and solid polymer electrolyte fillers dispersed within pores of the porous host.

2. The solid-state electrolyte of claim 1, wherein the porous host includes a porous polymer film and a flame-retardant material dispersed in the porous polymer film.

3. The solid-state electrolyte of claim 2, wherein the porous polymer film includes a polyimide.

4. The solid-state electrolyte of claim 2, wherein the flame-retardant material includes decabromodiphenyl ethane.

5. The solid-state electrolyte of claim 1, wherein the pores have sizes in a range of about 1 nm to about 10 μm, about 10 nm to about 10 μm, about 100 nm to about 10 μm, or about 100 nm to about 1 μm.

6. The solid-state electrolyte of claim 1, wherein the solid polymer electrolyte fillers include a solid polymer and a lithium salt.

7. The solid-state electrolyte of claim 6, wherein the solid polymer includes a polyalkylene oxide.

8. The solid-state electrolyte of claim 7, wherein the polyalkylene oxide is polyethylene oxide.

9. The solid-state electrolyte of claim 6, wherein the lithium salt includes lithium bis(trifluoromethanesulfonylimide.

10. A battery comprising an anode, a cathode, and the solid-state electrolyte of claim 1 disposed between the anode and the cathode.

11. The battery of claim 10, wherein the anode includes lithium metal.

12. A battery comprising an anode, a cathode, and the solid-state electrolyte of claim 2 disposed between the anode and the cathode.

13. A battery comprising an anode, a cathode, and the solid-state electrolyte of claim 3 disposed between the anode and the cathode.

14. A battery comprising an anode, a cathode, and the solid-state electrolyte of claim 4 disposed between the anode and the cathode.

15. A battery comprising an anode, a cathode, and the solid-state electrolyte of claim 5 disposed between the anode and the cathode.

16. A battery comprising an anode, a cathode, and the solid-state electrolyte of claim 6 disposed between the anode and the cathode.

17. A battery comprising an anode, a cathode, and the solid-state electrolyte of claim 7 disposed between the anode and the cathode.

18. A battery comprising an anode, a cathode, and the solid-state electrolyte of claim 8 disposed between the anode and the cathode.

19. A battery comprising an anode, a cathode, and the solid-state electrolyte of claim 9 disposed between the anode and the cathode.
